(19) United States
(12) Patent Application Publication
(10) Pub. No.: US 2025/0183602 A1
(43) Pub. Date: Jun. 5, 2025

(54) MOUNTING DEVICE AND APPARATUS FORMED THEREWITH

(71) Applicant: WAGO Verwaltungsgesellschaft mbH, Minden (DE)

(72) Inventors: Torben OBERHOMMERT, Minden (DE); Philipp OBER-WOERDER, Kirchlengern (DE)

(73) Assignee: WAGO Verwaltungsgesellschaft mbH, Minden (DE)

(21) Appl. No.: 18/964,819

(22) Filed: Dec. 2, 2024

(30) Foreign Application Priority Data
Nov. 30, 2023 (DE) 20 2023 107 084.1

(51) Int. Cl. H01R 13/74

(52) U.S. Cl. CPC H01R 13/745; H01R 13/748

(57) ABSTRACT

A mounting device for mounting an electrical connecting device on an object, having at least one first mounting element with which the mounting device can be mounted on the object. An apparatus is also provided having an electrical connecting device and at least one mounting device mounted on the electrical connecting device. The electrical connecting device can be a plug connector and/or a conductor connection terminal, for example.

This nonprovisional application claims priority under 35 U.S.C. § 119(a) to German Patent Application No. 20 2023 107 084.1, which was filed in Germany on Nov. 30, 2023, and which is herein incorporated by reference.

### BACKGROUND OF THE INVENTION

### Field of the Invention

The invention relates to a mounting device for mounting an electrical connecting device on an object, having at least one first mounting element with which the mounting device can be mounted on the object. The invention additionally relates to an apparatus having an electrical connecting device and at least one mounting device mounted on the electrical connecting device. The electrical connecting device can be a plug connector and/or a conductor connection terminal, for example.

### Description of the Background Art

Electrical and electronic equipment often has electrical connecting devices brought out from a housing wall with which the connection of electrical lines to the equipment is facilitated. The connecting device can then be inserted into an opening of a wall section and mounted on the surrounding housing wall there, for example by screwing. It is also known to mount such a connecting device in an opening of a wall section via elastic latching mounting arms, for example in a snap-in manner, as described in, for example, DE 10 2010 045 913 B4, which corresponds to US 2012/0071023, which is incorporated herein by reference.

### SUMMARY OF THE INVENTION

It is therefore object of the invention to provide a mounting device that can be used especially universally for mounting an electrical connecting device as well as an apparatus formed therewith.

This object is attained in a mounting device by the means that the mounting device has at least one second mounting element with which the mounting device can be mounted on the object, wherein the second mounting element is designed with a different mounting functionality from the first mounting element. The invention has the advantage that an electrical connecting device can be mounted in different ways on an object or on various objects with the very same mounting device, for example in different spatial orientations or with different types of installation. For this purpose, the mounting device has a first and a second mounting element, wherein these mounting elements are designed with different mounting functionality, i.e., as different functional mounts, for example on the one hand for a latching without additional installation elements and on the other hand via an additional installation element such as, e.g., a screw.

In this way, a universal mounting device is provided, by which means the variety of component parts is reduced. Costs, e.g. for inventory management, are thus reduced for the manufacturer as well as for the user.

Via one or more mounting devices according to the invention, an electrical connecting device can be mounted on an object such as, e.g., a sheet-metal part and/or a housing wall of a piece of equipment, for example on a wall section of a housing wall. The wall section can be part of a housing wall of a housing of electrical or electronic equipment.

The first mounting element can be designed as an elastically deflectable latching mounting arm, with which the mounting device can be mounted in an opening of a wall section of the object by latching. This permits simple and rapid mounting of the mounting device, and thus also of the electrical connecting device attached to the mounting device, on the wall section. In particular, no tool is required for this purpose, nor are any additional installation elements. The mounting can be produced in the manner of a snap-in attachment.

The second mounting element can be configured to mount the mounting device on the object via a screw connection. In this way, a different type of mounting can also be chosen with the same mounting device when this is necessary. The mounting device, and thus the electrical connecting device attached thereto, can be secured on the object via the screw connection. The screw connection can have a screw and a nut, for example.

The mounting device can have at least two second mounting elements arranged in different spatial orientations, by which means the mounting device can be mounted on a wall section of the object in at least two different spatial alignments relative to the wall section of the object. In this case, the at least two second mounting elements can each be configured for mounting via a screw connection, for example. In this way the mounting device, and thus the electrical connecting device attached thereto, can be mounted on the object in different orientations. In this context, the mounting need not necessarily take place in an opening of a wall section of the object; mounting on a continuous wall surface is also possible. For example, a mounting of the mounting device in an opening of a wall section can be carried out with one second mounting element, and a mounting on a continuous wall surface with the other second mounting element.

The second mounting element can be designed in the form of one or more through-openings in a base body of the mounting device and at least one screw support surface, wherein a screw can be passed through the one or more through-openings, and a screw head or a threaded nut of the screw can be supported on the screw support surface. With this alone, the mounting device advantageously provides essential aids, in particular the screw support surface, for fastening the screw connection. The screw, for example its thread section and/or its screw head, can be passed through the through-openings. The mounting of the mounting device on the object is then accomplished with a screw connection via the screw while utilizing the screw support surface and the one or more through-openings.

The through-openings can extend in the longitudinal direction through the entire mounting device, i.e., through the base body. In an example, the through-openings are arranged in alignment with one another in the longitudinal direction of the mounting device.

If multiple second mounting elements are present that are oriented in different spatial orientations, they can each have one or more through-openings of the type explained above as well as at least one screw support surface.

For example, the through-openings in one second mounting element can extend through the mounting device in the longitudinal direction, and in a different second mounting element can extend through the mounting device perpendicular thereto in the transverse direction.

The mounting device can have a receiving cavity for receiving a screw head or a threaded nut of a screw passed through at least one through-opening. In this way, the screw head or the threaded nut can be received on the mounting device in a manner that is completely or at least largely covered, and therefore requires no additional installation space.

At least one through-opening extends through at least one part of a latching mounting arm of the mounting device, in particular extends through in the longitudinal direction of the latching mounting arm. In this way, the screw can be passed entirely or partially through the latching mounting arm as well. As a result, the universal applicability of the mounting device is further improved.

The second mounting element can have at least one through-opening with a first diameter, through which a thread of the screw, but not the screw head, can be passed, and the second mounting element has at least one through-opening with a second diameter that is larger than the first diameter so that the screw head can be passed through. The through-opening with the first diameter is therefore dimensioned too small for the screw head. For example, a through-opening on the screw support surface can have the first diameter. The through-opening in the latching mounting arm can have the second diameter. In this way, the screw can be received largely in the mounting device.

The mounting device can have at least one attachment element, with which the mounting device can be mounted on a mating attachment element of the electrical connecting device that is designed as a counterpart to the attachment element. This permits simple and rapid attachment of the mounting device to the electrical connecting device, e.g., by interlocking engagement and/or frictional engagement. For example, the mating attachment element can be formed on a housing of the electrical connecting device.

The at least one attachment element can be designed as an interlocking attachment element that can be mounted on the mating attachment element of the electrical connecting device via interlocking engagement. The attachment element can be designed as a rail-like contour with an undercut, for example with a dovetail profile.

The mounting device can be designed as a plastic component, in particular as an injection molded plastic component. This permits simple and economical manufacture of the mounting device, in particular in mass production, and therefore economical provision for the user.

The above-mentioned object is additionally attained by an apparatus having an electrical connecting device and having at least one mounting device of the type explained above mounted on the electrical connecting device. The advantages explained above can also be realized herewith.

The electrical connecting device can have an insulating housing, for example. On the housing, a mating mounting element for fastening a mounting device can be present on each of two sides of the housing that face away from one another.

At least two mounting devices of the above-described type can be mounted on the electrical connecting device on sides of the electrical connecting device that face away from one another. This improves the universal applicability of the mounting device still further. Multiple mounting devices of the same type can therefore be mounted on the connecting device, which further reduces the variety of component parts. The electrical connecting device can be mounted on the object in an especially stable and secure manner owing to the at least two mounting devices.

The mounting device can be designed with mirror symmetry, at least along a plane in the longitudinal extent. Then two identically designed mounting devices can be mounted symmetrically on the connecting device in a simple manner.

The apparatus can, at the user's option, be mounted in an opening of a wall section of the object via at least one first mounting element of the mounting device or be mounted in the opening of the wall section of the object or at another point on the object via at least one second mounting element of the mounting device.

The user consequently has a variety of possibilities for using the mounting device according to the invention.

The apparatus can be mounted on a wall section of the object in one of at least two different spatial alignments relative to the wall section of the object, in particular in mutually orthogonally oriented alignments, at the user's option, via at least two different second mounting elements of the mounting device. If the electrical connecting device is designed as an electrical plug connector that can be mated with a mating connector in a given plug-in direction, then one spatial alignment can be a plane extending in the plug-in direction, for example, and another spatial alignment can be a plane extending perpendicular to the plug-in direction.

The at least one mounting device or the at least two mounting devices can be mounted permanently on the electrical connecting device, in particular by formation as a single piece with the electrical connecting device. The at least one or the at least two mounting devices can, for example, be designed as a single piece with the housing of the electrical connecting device. In this case, the housing of the electrical connecting device, for example, can be produced in a manufacturing process with the at least one or the at least two mounting devices, e.g., in a plastic injection molding process. It is also possible that the at least one or the at least two mounting devices are mounted permanently on the electrical connecting device in another manner, for example by adhesive bonding.

The at least one mounting device or the at least two mounting devices can be mounted on a mating attachment element of the electrical connecting device via their attachment element. In this way, flexibility for the user is increased still further.

The mounting device according to the invention can combine, in one component, a mounting element in the form of a snap-in latching arm and a mounting element in the form of at least one threaded flange. For example, the mounting device can have the first mounting element on a first end and one or more second mounting elements on a second, opposite end.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 4 show a mounting device in different views,

FIG. 5 shows an electrical connecting device,

FIG. 6 shows the electrical connecting device from FIG. 5 with two mounting devices,

FIG. 7 shows an apparatus having an electrical connecting device and two mounting devices in a first type of installation,

FIG. 8 shows the apparatus from FIG. 7 in a second type of installation, and

FIG. 9 shows the apparatus from FIG. 7 in a third type of installation.

### DETAILED DESCRIPTION

Here, FIG. 2 shows a side view, FIG. 6 a front view, and the remaining figures each show perspective views.

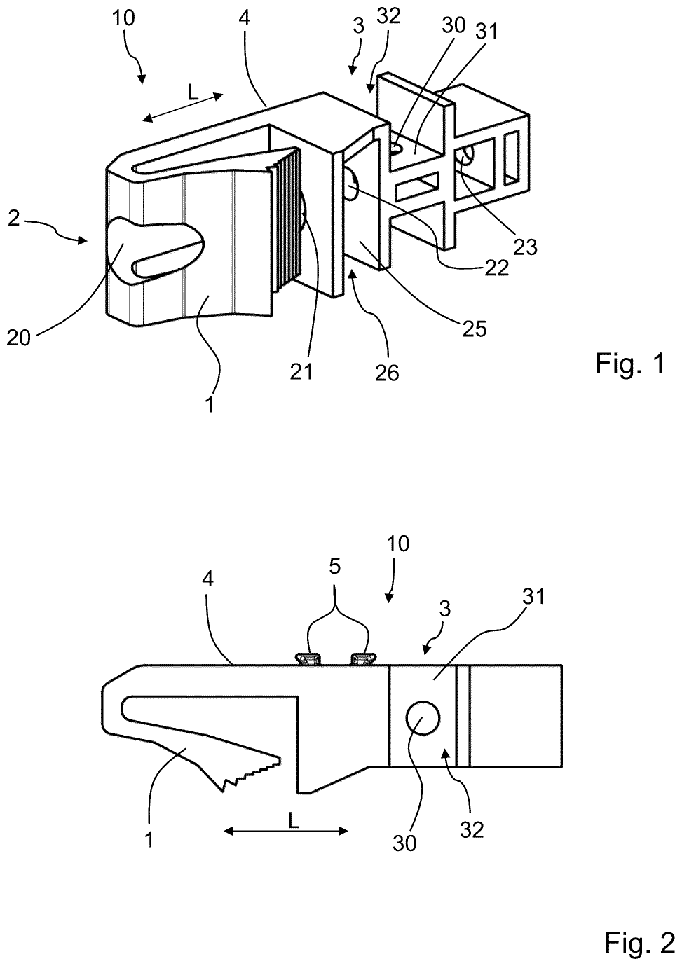

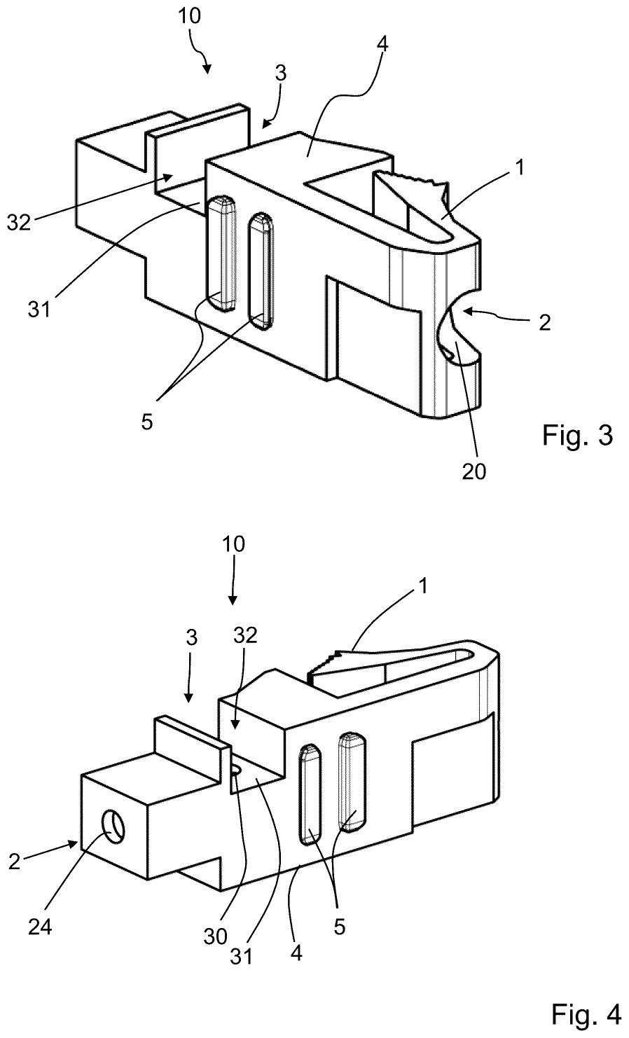

To start with, the design of a mounting device 10 is explained with reference to FIGS. 1 to 4. The mounting device 10 has a base body 4, on a first end of which is arranged a first mounting element 1 in the form of a latching mounting arm. A snap-in mounting in an opening of a wall section of an object can be carried out via the first mounting element 1. For this purpose, the latching mounting arm preferably has multiple latching edges at one free end.

The mounting device 10 has a second mounting element 2 that is configured for mounting via a screw connection. The second mounting element 2 has multiple through-openings 20, 21, 22, 23, 24 that are arranged in alignment one after the other in the longitudinal direction of the mounting device 10 and that pass through the base body 4, and also has a screw support surface 25. As can be seen, the first through-opening 20 passes through the latching mounting arm. The through-openings 20, 21 have a larger diameter than the through-openings 22, 23, 24 that follow. This makes it possible to insert the screw head of a screw through the mounting device 10 in the longitudinal direction in such a manner that the screw head comes to rest on the screw support surface 25 and the thread section of the screw extends through the further through-openings 22, 23, 24.

The mounting device 10 has an additional second mounting element 3 that likewise is configured for mounting via a screw connection. The additional second mounting element 3 has one or more through-openings 30 as well as a screw support surface 31. The one or more through-openings 30 extend in a direction that is orthogonal to the longitudinal direction L of the mounting device 10, which is to say likewise orthogonal to the aligned arrangement of the through-openings 20, 21, 22, 23, 24. In this way, the mounting device 10 can be secured on an object with a screw that is passed through orthogonally to the longitudinal direction L.

The mounting device 10 has a receiving cavity 26 for a screw head supported on the screw support surface 25. An additional receiving cavity 32 is present for a screw head supported on the screw support surface 31.

In addition, the mounting device 10 has, on one side of the base body 4, attachment elements 5 on which an electrical connecting device can be mounted via interlocking engagement and/or frictional engagement.

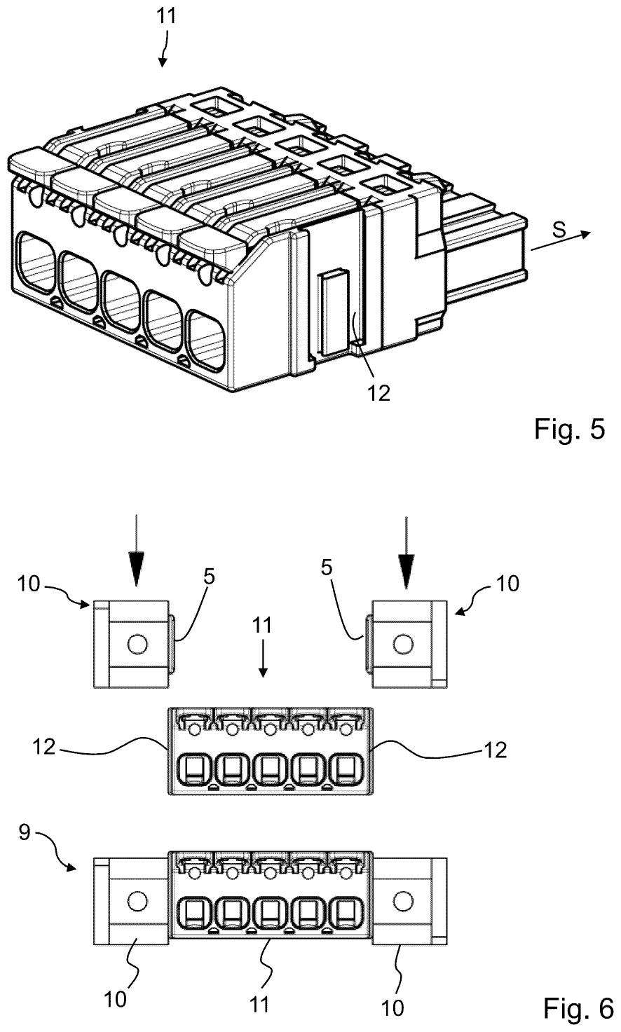

FIG. 5 shows an electrical connecting device 11 that has, on each of two sides of its housing that face away from one another, mating attachment elements 12 that are designed as counterparts to the attachment elements 5 with regard to their shape. Advantageously, in this case the attachment elements 5 and the mating attachment elements 12 are configured for mounting of the mounting device 10 in two alignments that are each rotated by 180 degrees relative to one another, which is to say the mounting device 10 can optionally be mounted on the electrical connecting device 11 in a direction in which the first mounting element 1 faces in the plug-in direction S of the electrical connecting device 11, or in the opposite direction, in which the first mounting element 1 faces opposite the plug-in direction S.

The top part of FIG. 6 shows how two mounting devices 10 can be mounted via a sliding motion on the electrical connecting device 11 via the attachment elements 5 and the mating attachment elements 12. In this process, an apparatus 9 shown at the bottom in FIG. 6 is produced, which has the electrical connecting device 11 and alternatively one mounting device 10 or, as shown, two mounting devices 10, and in this way constitutes a modular unit that can be mounted on an object by the user.

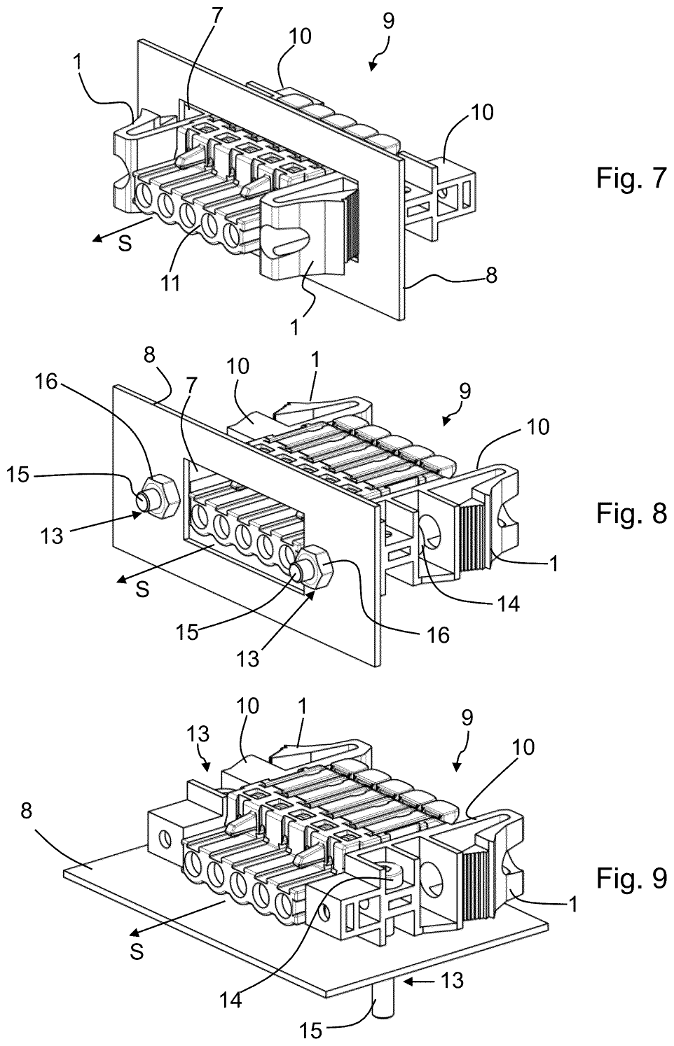

FIG. 7 illustrates a first possibility for mounting the apparatus 9 on a wall section 8 of a piece of equipment. The wall section 8 has an opening 7. The apparatus 9 can be snapped into place on two inner edges of the opening 7 via the first attachment elements 1, which is to say the latching mounting arms. The apparatus 9 is therefore mounted on the wall section 8 in a spatial alignment in which the plug-in direction S is essentially orthogonal to the wall section 8 or orthogonal to the plane of the wall section 8.

FIG. 8 shows an alternative possibility for mounting the apparatus 9 on the wall section 8, which again has the opening 7. In this case, the mounting is accomplished with a mounting device 10 that is fastened on the connecting device 11 in the opposite direction in such a manner that the second mounting elements 2 are oriented toward the wall section 8, and the mounting is accomplished via a screw connection, which is to say via screws 13 that are secured on the wall section 8 by their respective thread section 15 with the aid of a nut 16. In this context, the screw head 14 of the screw 13 is supported on a respective screw support surface 25 of the mounting device 10 and received within the receiving cavity 26. Here, too, the plug-in direction S faces in a direction orthogonal to the wall section 8.

FIG. 9 shows an alternative possibility for mounting the apparatus 9 on a wall section 8, which in this case need not necessarily have an opening 7. In this case, the mounting of the apparatus 9 is accomplished with the plug-in direction S parallel to the wall section 8 or parallel to the extent of the plane of the wall section 8. The additional second mounting elements 3 of the mounting devices 10 are used for this purpose. The mounting is again accomplished by a screw connection, which is to say by a screw 13 and a nut 16. In this context, the respective screw 13 is passed through the through-opening 30 and its screw head 14 is supported on the screw support surface 31. The screw head is then received in the receiving cavity 32.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mounting device for mounting an electrical connecting device on an object, the mounting device comprising:
at least one first mounting element with which the mounting device is adapted to be mounted on the object; and
at least one second mounting element with which the mounting device is adapted to be mounted on the object, the second mounting element having a different mounting functionality from the first mounting element.

2. The mounting device according to claim 1, wherein the first mounting element is designed as an elastically deflectable latching mounting arm, with which the mounting device is mounted in an opening of a wall section of the object by latching.

3. The mounting device according to claim 1, wherein the second mounting element is configured to mount the mounting device on the object via a screw connection.

4. The mounting device according to claim 1, wherein the mounting device has at least two second mounting elements arranged in different spatial orientations, via which the mounting device is mounted on a wall section of the object in at least two different spatial alignments relative to the wall section of the object.

5. The mounting device according to claim 1, wherein the second mounting element is designed in the form of one or more through-openings in a base body of the mounting device and at least one screw support surface, and wherein a screw is adapted to be passed through the one or more through-openings, and a screw head or a threaded nut of the screw is supported on the screw support surface.

6. The mounting device according to claim 5, wherein the mounting device has a receiving cavity for receiving a screw head or a threaded nut of a screw passed through at least one through-opening.

7. The mounting device according to claim 5, wherein at least one through-opening extends through at least one part of a latching mounting arm of the mounting device or extends through in the longitudinal direction of the latching mounting arm.

8. The mounting device according to claim 5, wherein the second mounting element has at least one through-opening with a first diameter, through which a thread of the screw, but not the screw head, is passed, and the second mounting element has at least one through-opening with a second diameter that is larger than the first diameter so that the screw head is passed through.

9. The mounting device according to claim 1, wherein the mounting device has at least one attachment element, with which the mounting device is mounted on a mating attachment element of the electrical connecting device that is designed as a counterpart to the attachment element.

10. The mounting device according to claim 9, wherein the at least one attachment element is designed as an interlocking attachment element that is mounted on the mating attachment element of the electrical connecting device via an interlocking engagement.

11. The mounting device according to claim 1, wherein the mounting device is designed as a plastic component, or as an injection molded plastic component.

12. An apparatus comprising:
an electrical connecting device; and
at least one mounting device according to claim 1 that is mounted on the electrical connecting device.

13. The apparatus according to claim 12, wherein at least two mounting devices are mounted on the electrical connecting device on sides of the electrical connecting device that face away from one another.

14. The apparatus according to claim 12, wherein the apparatus is, at a user's option, mounted in an opening of a wall section of the object by at least one first mounting element of the mounting device or be mounted in the opening of the wall section of the object or at another point on the object by at least one second mounting element of the mounting device.

15. The apparatus according to claim 12, wherein the apparatus is mounted on a wall section of the object in one of at least two different spatial alignments relative to the wall section of the object or in mutually orthogonally oriented alignments, at the user's option, by at least two different second mounting elements of the mounting device.

16. The apparatus according to claim 12, wherein the at least one mounting device or the at least two mounting devices are mounted permanently on the electrical connecting device by formation as a single piece with the electrical connecting device.

17. The apparatus according to claim 12, wherein the at least one mounting device or at least two mounting devices are mounted on a mating attachment element of the electrical connecting device by their attachment element.
